(19) United States
(12) Patent Application Publication
(10) Pub. No.: US 2007/0071243 A1
(43) Pub. Date: Mar. 29, 2007

(54) Key validation service

(75) Inventor: Arun K. Nanda, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/233,671

(22) Filed: Sep. 23, 2005

(51) Int. Cl. H04L 9/00

(52) U.S. Cl. 380/277

(57) ABSTRACT

A key validation service (KVS) provides the ability to assess the validity of the private key used to send secure information. Each time a user wants to send information to a recipient, the user first sends proof to the KVS that the user's private key is valid. When the KVS is assured that the user's private key is valid and has not been compromised, the key validation service creates a confirmation of validity (COV) which is encrypted using the KVS's own private key. If however, the KVS receives an indication that the user's private key has been compromised (e.g., stolen), the KVS will not issue the COV. The user sends the COV and other information to the recipient. The recipient, who has been provided the KVS's public key, decrypts the COV with the KVS's public key to determine if the user's private key is valid and has not been compromised.

### TECHNICAL FIELD

The technical field generally relates to computers and computer systems and more specifically relates to secure communications utilizing computers and computer systems.

### BACKGROUND

Security is an ongoing concern when providing information via a computer network. For example, a typical user prefers that his or her digital identity (e.g., personal information pertaining to the user) remains secure during transmission of the digital identity over a computer network. Also, it is not uncommon for the security of downloaded software (e.g., music purchased over the Internet) to be maintained to prevent unauthorized access to the software. Public-key cryptography is often used to securely transmit information over a network. Public-key cryptography uses a pair of keys. One key is used to encrypt and the other is used to decrypt. Knowledge of one key does not provide knowledge of the other key. Typically one key is kept private, and thus called the private key. The other key typically is made public, and often referred to as the public key. Public keys are usually distributed as part of certificates. Mechanisms have been implemented to ensure the legitimacy of public keys. These mechanisms include certificate revocation lists and various forms of online certificate status protocols. These mechanisms are used to ascertain that the certificate, and hence the public key in it, is still legitimate. Using these mechanisms is often cumbersome, tedious, and time consuming; imposing a heavy burden on the system utilizing them. Also, these mechanisms do not lend themselves well for use by individuals, small groups or organizations due to the heavy infrastructure burden associated with them.

### SUMMARY

A key validation service provides the ability to assess the validity of a private key used in the transmission of secure information. The key validation service can be used to vouch for the validity of the private key used by a user to send secure information to a recipient. The key validation service creates its own public-key cryptographic pair of keys. Each time the user wants to send information to a recipient, the user first sends proof to the key validation service that the user's private key is valid. When the key validation service is assured that the user's private key is valid and has not been compromised, the key validation service creates a confirmation of validity. If however, the key validation service receives an indication that the user's private key has been compromised (e.g., the private key owner notifies the key validation. service that the user's private key has been stolen.), the key validation service will not issue the confirmation of validity. The confirmation of validity is created using the key validation service's private key. The confirmation of validity is sent to the user. The user sends the confirmation of validity along with other information to the recipient. The recipient, who has been provided the key validation service's public key, decrypts the confirmation of validity with the key validation service's public key to determine if the user's private key is valid and has not been compromised.

### BRIEF DESCRIPTION OF THE DRAWINGS

The foregoing and other objects, aspects and advantages will be better understood from the following detailed description with reference to the drawings, in which:

FIG. 1 is a block diagram of an exemplary key validation processor;

FIG. 2 is a diagram of an exemplary system comprising a key validation service;

FIG. 3 is a flow diagram of an exemplary sequence of events for providing a key validation service; and

FIG. 4 is a diagram of an exemplary process for providing a key validation service.

### DETAILED DESCRIPTION OF ILLUSTRATIVE EMBODIMENTS

In an exemplary embodiment, a key validation service is used to vouch for the validity of a public-key based digital identity. The public key used with the digital identity is registered with the key validation service. Every use of that public key is accompanied by a confirmation of validity issued by the key validation service. The confirmation of validity is an indication that the private key corresponding to the public key is valid and that the private key has not been compromised. If the private key is comprised, or suspected of being comprised, the private key owner can notify the key validation service. Subsequently, the key validation service will not issue the confirmation of validity. No further assertions of the private key's validity will be issued by the key status service until the problem is resolved. The key validation service can be administered by the private key owner via a processor, such as a personal computer for example, or be administered by an entity independent of the private key owner.

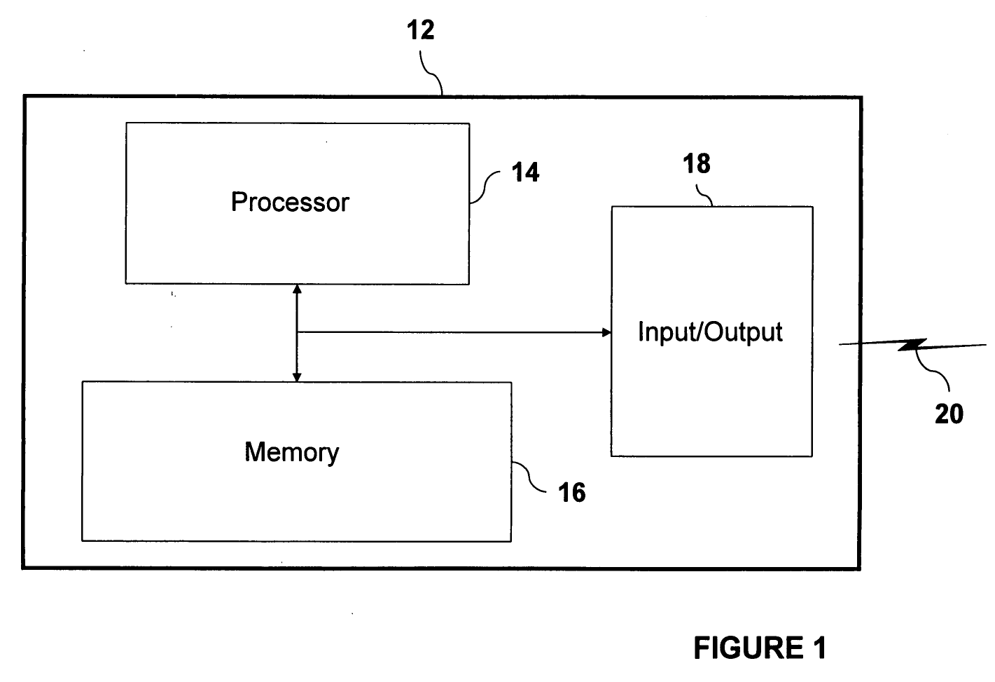

FIG. 1 is a block diagram of an exemplary key validation processor 12 comprising processing portion 14, input/output portion 16, and memory portion 18. The key validation processor 12 can comprise any appropriate processor. Examples of appropriate processors include general purpose processors, dedicated processors, desktop computers, laptop computers, Personal Digital Assistants (PDAs), handheld computers, smart phones, server processors, client processors, or a combination thereof. The key validation processor 12 can be implemented in a single processor, such as a computer, or multiple processors. Multiple processors can be distributed or centrally located. Multiple processors can communicate wirelessly, via hard wire, or a combination thereof. For example, each portion of the processor 12 (i.e., the processor portion 14, the memory portion 16, and the input/output portion 18) can be implemented via multiple distributed processors, nodes and/or databases. In an exemplary embodiment, the key validation processor 12 can communicate with at least one other entity via interface 20. The interface 20 can comprise any appropriate interface, such a wireless interface, a wired interface, or a combination thereof.

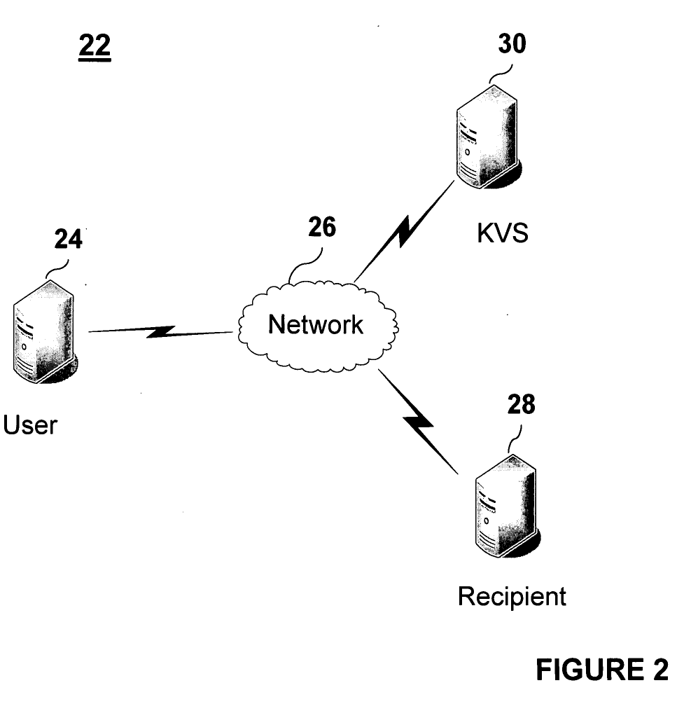

FIG. 2 is a diagram of an exemplary system 22 comprising a key validation service (KVS) 30, a user 24, and a recipient 28. In an exemplary embodiment, the KVS 30 comprises the key validation processor 12. Each of the user 24 and recipient 28 can be implemented in any appropriate manner, such as by a processor for example. Appropriate exemplary processors for implementing each of the user 24 and the recipient 28 include general purpose processors, dedicated processors, desktop computers, laptop computers, Personal Digital Assistants (PDAs), handheld computers, smart phones, server processors, client processors, or a combination thereof. Each of the user 24 and the recipient 28 can be implemented in a single processor, such as a computer, or multiple processors. Multiple processors can be distributed or centrally located. Multiple processors can communicate wirelessly, via hard wire, or a combination thereof. For example, each portion of the user 24 and the recipient 28 can be implemented via multiple distributed processors, nodes and/or databases. The interfaces used by the user 24 and the recipient 28 to communicate via the network 26 can comprise any appropriate interface, such a wireless interface, a wired interface, or a combination thereof. Any of a wide variety of communications protocols can be used to communicate via the network 26, including both public and proprietary protocols. Examples protocols include TCP/IP, IPX/SPX, and NetBEUI.

The user 24, the KVS 30 and the recipient 28 communicate via the network 26. The network 26 represents any of a wide variety of data communications means. The network 26 can include wired network or direct-wired connection. The network 26 can comprise public portions (e.g., the Internet) as well as private portions (e.g., a residential Local Area Network (LAN)), or a combination thereof. The network 26 can be implemented using any one or more of a wide variety of conventional communications media including both wired and wireless media such as acoustic, RF, infrared and other wireless media.

Referring now to FIG. 1 and FIG. 2, in an exemplary embodiment, the user 24 establishes a public-key cryptographic key pair for communicating with an intended recipient 28. The public-key pair comprises the user's public key (Pu) and the user's private key (Ku). The user registers Pu with the key validation service, KVS, 30. The user 24 can register Pu with the KVS 30 in any appropriate manner. For example, the user 24 can transmit Pu to the KVS 30. The KVS 30, utilizing the key validation processor 12 receives Pu via the input/output portion 18. The KVS 30 stores Pu in the memory portion 16.

The user 24 also submits proof of knowledge of the user's private key, Ku, to the KVS 30. Proof of knowledge of Ku can comprise any appropriate means. For example, proof of knowledge of Ku can comprise a predetermined entity, such as value, character, data string, or the like. In an exemplary embodiment, the predetermined entity is encrypted with the user's private key, Ku. The KVS 30 receives the proof of knowledge via the input/output portion 18 of the key validation processor 12. The KVS 30 utilizes the proof of knowledge of Ku to determine if Ku is valid. In an exemplary embodiment the KVS 30 decrypts the proof of knowledge utilizing the user's public key, Pu, to determine if Ku is valid. For example, the KVS 30 can decrypt the proof of knowledge via the processor portion 14 of the key validation processor 12. If the decrypted proof of knowledge matches the predetermined entity, the user's private key, Ku is determined to be valid. Utilizing a predetermined proof of knowledge of Ku implies that the KVS 30 has knowledge of the predetermined entity.

In another exemplary embodiment, the proof of knowledge of Ku comprises a response to a challenge. As is known in the art, prior to two entities communicating over a network, in accordance with various protocols, one entity can challenge another entity. The challenged entity provides a response that is determined in accordance with an algorithm that is known to both entities. For example, the response can comprise a random number generated from a seed determined in accordance with the commonly known algorithm. In an exemplary embodiment, the proof of knowledge of Ku can comprise this random number response to a challenge by the KVS 30. The random number is encrypted by the user 24 utilizing Ku and transmitted to the KVS 30. As described above, the KVS 30 decrypts the proof of knowledge to determine if Ku is valid.

The KVS 30, too, establishes a public-key cryptographic key pair comprising the KVS's public-key (Ps) and the KVS's private key (Ks). In an exemplary embodiment, the KVS 30 utilizes the processor portion 14 of the key validation processor 12 to establish Ps and Ks and stores Ps and Ks in the memory portion 16 of the key validation processor 12. After the user 24 sends proof of knowledge of Ku to the KVS 30, and the KVS 30 determines that Ku is valid, the KVS 30 sends to the user 24 the KVS's public key Ps. In an exemplary embodiment, the KVS 30 utilizes the input/output portion 18 of the key validation processor 12 to transmit Ps.

Prior to communication with an intended recipient, such as the recipient 28, the user 24 registers the user's public key, Pu, and the KVS's public key, Ps, with the intended recipient 28. The user 24 can register Pu and Ps with the recipient 28 in any appropriate manner. For example, the user can transmit Pu and Ps to the recipient 28. Or, Pu and Ps can be made available via a service which the recipient 28 can access.

Each time the user wishes to communicate with an intended recipient, such as the recipient 28, the user first submits proof of knowledge of Ku to the KVS 30. This submission of proof of knowledge of Ku can take any of the forms described above. The KVS 30 receives the submission of proof of knowledge of Ku and determines if Ku is valid as described above. The KVS 30 also determines if Ku has been comprised. For example, if the user knows that Ku has been stolen, the user can alert the KVS 30. If the KVS 30 determines that Ku is valid and has not been compromised, the KVS 30 sends a confirmation of validity (COV) to the user 24. In an exemplary embodiment, the processor portion 14 of the key validation processor 12 creates the COV. In an exemplary embodiment, the COV is created using the KVS's private key, Ks. For example, the COV can comprise a predetermined entity, such as value, character, data string, or the like. In an exemplary embodiment, the predetermined entity, along with the public key, Pu, of the user being confirmed, is encrypted with Ks to create the COV.

The user 24, in receipt of the COV, sends proof of knowledge of Ku and the COV to the recipient 28. The proof of knowledge of Ku can comprise any of the forms described above. The recipient 28 utilizes the proof of knowledge of Ku to determine if Ku is valid. The recipient 28 can make this determination in any of the manners described above. The recipient decrypts the COV utilizing Ps. In an exemplary embodiment, the recipient has knowledge of the entity that was encrypted with Ks to create the COV. The recipient 28 compares the decrypted COV with the expected value of the decrypted COV. If they match, that communications between the user 24 and the recipient 28 can proceed. If they do not match, communications are not allowed.

The KVS 30 can be administered by the owner of Ks (e.g., the user 24) or can be administered by an independent entity having no knowledge of Ks.

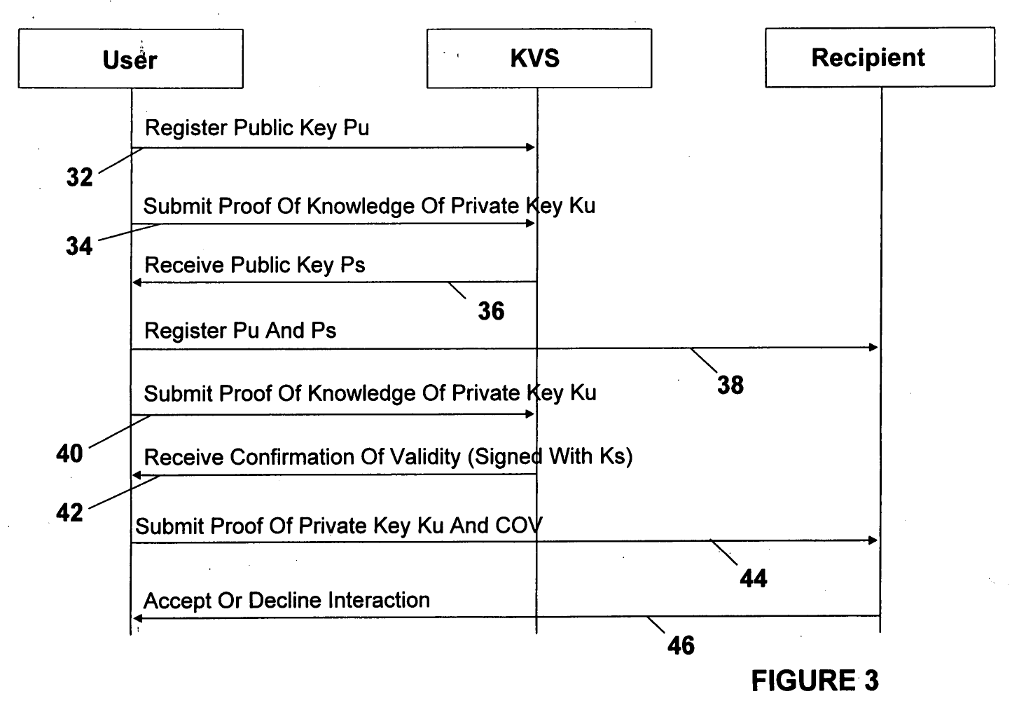

FIG. 3 is a flow diagram of an exemplary sequence of events for providing a key validation service. The user registers the user's public key, Pu, with the key validation service, KVS, at step 32. As described above, the user can send Pu to the KVS, or the user can make Pu available to the KVS via any appropriate service. The user submits proof of knowledge Ku to the KVS at step 34. As described above, proof of knowledge can be in the form of a predetermined proof of knowledge, in the form of a response to a challenge, or a combination thereof. If it is determined that Ku is valid in accordance with the submitted proof of knowledge of Ku, the KVS provides the KVS's public key, Ps, to the user at step 36. Prior to beginning communications with the intended recipient, the user registers Pu and Ps with the intended recipient at step 38. The recipient can store Pu and Ps for later use. As described above, the user can provide Pu and Ps to the recipient or the user can make Pu and Ps available to the recipient via any appropriate service. At step 40, the user submits proof of knowledge of Ku to the KVS. The KVS determines if Ku is valid and/or if Ku has been compromised. The KVS can determine if Ku is valid in any appropriate manner, for example as described above, by decrypting the proof of knowledge of Ku with Pu and determining if the decrypted value of the proof of knowledge of Ku matches an expected value. The KVS can also determine that Ku has been compromised if the KVS has been notified thereof. For example, the KVS can be notified that Ku has been stolen, that Ku is no longer in use, that Ku is no longer valid, or a combination thereof. Notification can be provided by any authorized source, such as the user or a designated agent of the user, for example.

If the KVS determines that Ku is valid and has not been compromised, the KVS provides a confirmation of validity, COV, to the user at step 42. As described above, in an exemplary embodiment, the COV comprises an entity encrypted with Ks. The entity can comprise a predetermined entity or a response to a challenge, as described above. The user provides the COV and proof of knowledge of Ku to the recipient at step 44. This proof of knowledge of Ku can comprise any of the forms described above. The recipient analyzes the COV and the proof of knowledge of Ku to determine if Ku is valid. The recipient can perform this analysis in any of the manners described above. At step 46, the recipient provides to the user and indication whether communications can proceed or not.

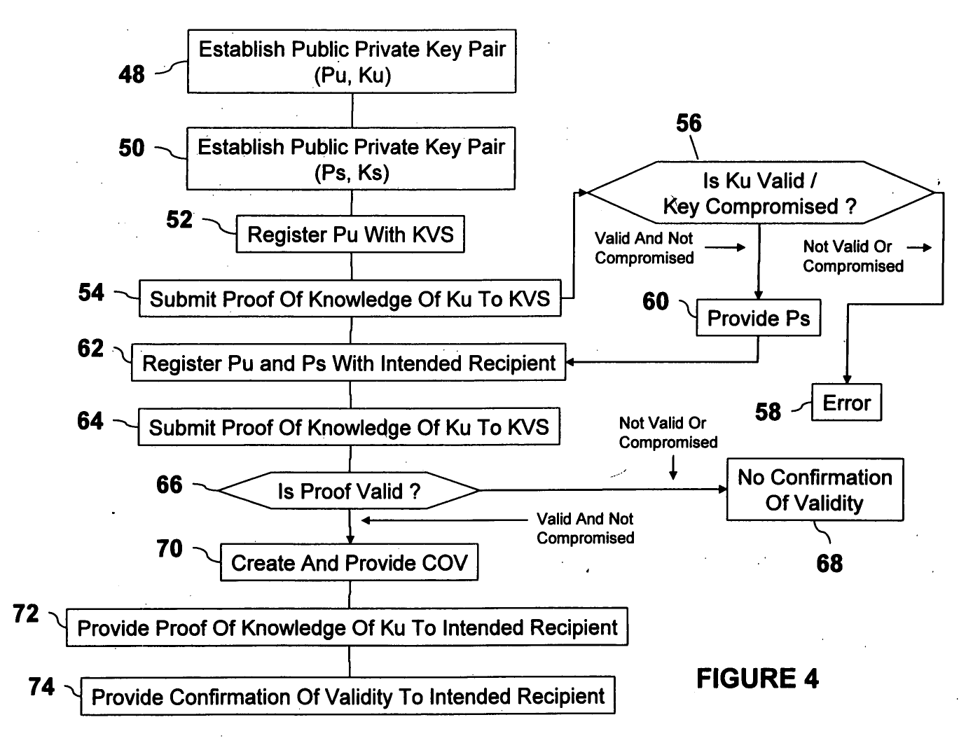

FIG. 4 is a diagram of an exemplary process for providing a key validation service. The steps depicted in FIG. 4 can be performed in accordance with any of the appropriate descriptions provided above. Accordingly, all steps depicted in FIG. 4 are not described in detail, but rather it is to be understood that the steps can be performed as described above. A first pair of public-key cryptographic keys is generated at step 48. In an exemplary embodiment, the first pair of keys comprises the user's public key, Pu, and the user's private key, Ku. A second pair of public-key cryptographic keys is generated at step 50. In an exemplary embodiment, the second pair of keys comprises the key validation service's (KVS's) public key, Ps, and the KVS's private key, Ks. Pu is registered with the KVS at step 52. Pu can be registered with the KVS in accordance with any of the descriptions provided above. Proof of knowledge of Ku is provided to the KVS at step 54. At step 56 it is determined if Ku if valid and/or if Ku has been compromised. If it is determined (step 56) that Ku is not valid or that Ku has been compromised, an error is reported at step 58. In an exemplary embodiment, reporting an error at step 58 comprises sending a message to the provider (e.g., the user) of the proof of knowledge of Ku that Ku is not valid and/or Ku has been compromised.

If it is determined (step 56) that Ku is valid and has not been compromised, Ps is provided at step 60. In an exemplary embodiment, Ps is provided to the user. Accordingly, the user registers Pu and Ps at step 62. Pu and Ps can be registered in any appropriate manner as described above, so that the intended recipient has access to Pu and Ps. Knowledge of Ku is submitted to the KVS at step 64. The KVS determines if Ku is valid and/or if Ku has been compromised at step 66. If Ku is determined (step 66) to be not valid or to have been compromised, a confirmation of validity (COV) is not created (step 68). Step 68 can also include providing a message to the provider (e.g., the user) of the provider of the proof of knowledge of Ku that Ku is not valid and/or Ku has been compromised.

If it is determined (step 66) that Ku is valid and Ku has not been compromised, the KVS creates the COV and provides the COV at step 70. The COV is provided to the provider of the proof of knowledge of Ku (e.g., the user). Proof of knowledge of Ku is provided to the intended recipient at step 72. The COV is provided to the intended recipient at step 74. If it is determined (e.g., by the intended recipient) that Ku is valid and that the COV is valid, a message is sent to the user indicating that communications can begin.

The various techniques described herein may be implemented in connection with hardware or software or, where appropriate, with a combination of both. Thus, the methods and apparatuses for a key validation service or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for a key validation service. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatuses for a key validation service also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for a key validation service. When implemented on a general-purpose processor, the program code combines with the processor to provide a unique apparatus that operates to invoke the functionality for a key validation service. Additionally, any storage techniques used in connection with a key validation service can invariably be a combination of hardware and software.

While methods and apparatuses for a key validation service have been described in connection with the illustrative embodiments of the various figures, it is to be understood that other similar embodiments may be used or modifications and additions may be made to the described embodiments for performing the same function for a key validation service without deviating therefrom. Therefore, methods and apparatuses for a key validation service should not be limited to any single embodiment, but rather should be construed in breadth and scope in accordance with the appended claims.

What is claimed:

1. A method for providing a key validation service, said method comprising:
providing a first public key of a first pair of public-key cryptographic keys comprising said first public key and a first private key, wherein said provided first public key is available to a key validation service;
providing a second public key of a second pair of public-key cryptographic keys comprising said second public key and a second private key, wherein said provided first public key and said provided second public key are available to an intended recipient;
providing a first proof of knowledge of said first private key, wherein said provided first proof of knowledge is available to said key validation service;
receiving, in response to said provided first proof of knowledge, a confirmation of validity indicative of a validity of said first private key, said confirmation of validity being created utilizing said second private key;
providing said confirmation of validity and a second proof of knowledge of said first private key, wherein said provided confirmation of validity and said provided second proof of knowledge are available to said intended recipient.

2. A method in accordance with claim 1, wherein:
said key validation service has no knowledge of said first private key; and
said key validation service has possession of said second private key.

3. A method in accordance with claim 1, further comprising providing said confirmation of validity if said first proof of knowledge is valid and said first private key has not been compromised.

4. A method in accordance with claim 1, further comprising utilizing said second public key to determine if said confirmation of validity is valid.

5. A method in accordance with claim 1, further comprising accepting communication by said intended recipient if said second proof of knowledge and said confirmation of validity are determined to be valid.

6. A method in accordance with claim 1, wherein said validation service is administered by one of a possessor of said first private key and an entity independent of said possessor of said first private key.

7. A method in accordance with claim 1, wherein said first proof of knowledge comprises at least one of a predetermined proof of knowledge and a response to a challenge.

8. A key validation processor comprising:
an input/output portion for:
receiving a first public key of a first pair of public-key cryptographic keys comprising a first private key and said first public key;
receiving a proof of knowledge of said first private key;
providing a second public key of a second pair of public-key cryptographic keys comprising a second private key and said second public key;
providing a confirmation of validity indicative of a validity of said first private key; and
a processor portion for:
establishing said second pair of public-key cryptographic keys;
determining if said received proof of knowledge of said first private key is valid;
determining if said first private key has been compromised;
creating said confirmation of validity utilizing said second private key.

9. A key validation processor in accordance with claim 8, wherein said confirmation of validity is provided via said input/output portion if said first proof of knowledge is valid and said first private key has not been compromised.

10. A key validation processor in accordance with claim 8, wherein said key validation processor is administered by one of a possessor of said first private key and an entity independent of said possessor of said first private key.

11. A key validation processor in accordance with claim 8, wherein said proof of knowledge comprises at least one of a predetermined proof of knowledge and a response to a challenge.

12. A computer-readable medium having computer-executable instructions for performing the acts of:
providing a first public key of a first pair of public-key cryptographic keys comprising said first public key and a first private key, wherein said provided first public key is available to a key validation service, wherein said key validation service has no knowledge of said first private key;
providing a second public key of a second pair of public-key cryptographic keys comprising said second public key and a second private key, wherein said provided first public key and said provided second public key are available to an intended recipient, wherein said key validation service has possession of said second private key;
providing a first proof of knowledge of said first private key, wherein said provided first proof of knowledge is available to said key validation service;
receiving, in response to said provided first proof of knowledge, a confirmation of validity indicative of a validity of said first private key, said confirmation of validity being created utilizing said second private key;
providing said confirmation of validity and a second proof of knowledge of said first private key, wherein said provided confirmation of validity and said provided second proof of knowledge are available to said intended recipient.

13. A computer-readable medium in accordance with claim 12, said computer-readable medium having further computer-executable instructions for providing said confirmation of validity if said first proof of knowledge is valid and said first private key has not been compromised.

14. A computer-readable medium in accordance with claim 12, said computer-readable medium having further computer-executable instructions for utilizing said second public key to determine if said confirmation of validity is valid.

15. A computer-readable medium in accordance with claim 12, wherein said validation service is administered by one of a possessor of said first private key and an entity independent of said possessor of said first private key.

16. A computer-readable medium in accordance with claim 12, wherein said first proof of knowledge comprises at least one of a predetermined proof of knowledge and a response to a challenge.
